(19) United States
(12) Patent Application Publication
(10) Pub. No.: US 2005/0177640 A1
(43) Pub. Date: Aug. 11, 2005

(54) Method for selectively providing access to voice and data networks by use of intelligent hardware

(76) Inventors: Alan Rubinstein, Fremont, CA (US); Russell Chang, San Jose, CA (US)

Correspondence Address: WAGNER, MURABITO & HAO LLP;Third Floor, Two North Market, San Jose, CA, 95113, US

(21) Appl. No.: 09/954,112

(22) Filed: Sep. 11, 2001

Related U.S. Application Data
(60) Provisional application No. 60/277,593, filed on Mar. 20, 2001.
(60) Provisional application No. 60/277,767, filed on Mar. 20, 2001.
(60) Provisional application No. 60/277,451, filed on Mar. 20, 2001.
(60) Provisional application No. 60/277,592, filed on Mar. 20, 2001.
(60) Provisional application No. 60/285,419, filed on Apr. 20, 2001.

(51) Int. Cl. G06F 15/16

(52) U.S. Cl. 709/229

(57) ABSTRACT

A method for selectively providing access to voice and data networks by use of intelligent hardware. The present invention provides security measures for controlling access to a network connection. An electronic device communicatively coupled to intelligent hardware initiates a request to access a network. The request is received at the intelligent hardware communicatively coupled to the network and configured to allow access to the network according to predetermined criteria. Provided the request satisfies the predetermined criteria, the electronic device is provided access to the network. The predetermined criteria may include placing geographic restrictions (e.g., the room the port is located in), temporal restrictions (e.g., weekend or nighttime restrictions), and user class restrictions (e.g., visitor restrictions or low-level employee restrictions) on specific ports of the intelligent hardware. In one embodiment, a central control site manages the predetermined criteria. In one embodiment, the present invention controls access to a corporate Intranet. In one embodiment, the intelligent device has specific access port serial number. The present invention provides a method of easier management of information systems.

### RELATED U.S. APPLICATIONS

This application claims priority to the copending provisional patent applications: patent application Ser. No. 60/277,593, attorney docket number 3COM-3650.BCG.US.PRO, entitled “‘Intellijack’ physical concepts,” with filing date Mar. 20, 2001, and assigned to the assignee of the present invention; patent application Ser. No. 60/277,767, attorney docket number 3COM-3651.BCG.US.PRO, entitled “A method for managing intelligent hardware for access to voice and data networks,” with filing date Mar. 20, 2001, and assigned to the assignee of the present invention; patent application Ser. No. 60/277,451, attorney docket number 3COM-3652.BCG.US.PRO, entitled “A method for filtering access to voice and data networks by use of intelligent hardware,” with filing date Mar. 20, 2001, and assigned to the assignee of the present invention; patent application Ser. No. 60/277,592, attorney docket number 3COM-3653.BCG.US.PRO, “‘Intellijack’ usage,” with filing date Mar. 20, 2001, and assigned to the assignee of the present invention; and patent application Ser. No. 60/285,419, attorney docket number 3COM-3722.BCG.US.PRO, “Intelligent concentrator,” with filing date Apr. 20, 2001, and assigned to the assignee of the present invention.

### FIELD OF INVENTION

The present invention relates to the field of computer networks. In particular, the present invention relates to a device and a method for selectively providing access to voice and data networks by use of intelligent hardware.

### BACKGROUND OF THE INVENTION

Modern businesses commonly integrate computer networks (both data and voice IP) into their business operations. Typically, network access ports are located throughout the place of business operations. An electronic device can often access the network by connecting with one of the network access ports.

Typical office buildings often have public spaces (e.g., areas open to the public on a regular basis) and private spaces (e.g., areas closed to the public, such as private offices and cubicles). Additionally, these public and private spaces often have gray zones, such as lobbies and conference rooms. Furthermore, some spaces are both public and private, depending on the times of day and the location (e.g., a main lobby during business hours and after business hours). As a result, it is often possible for people unaffiliated with the business to access the network. Thus, unaffiliated people may access the Internet, or possibly the company Intranet, simply by connecting to a network access port.

One way to attempt to control the access of persons to a network is to administer a password system, requiring a user to enter in a user name and password to access the network. However, passwords are often hard to administer, as they require a password control infrastructure. Furthermore, password systems are not completely effective against all attempts at circumventing security, and are often subject to dictionary or other automated means of attack.

Another way to attempt to control access to a network is to control access to locations of the office building where network access ports are located. This is not always effective, as individuals who desire to access the network may tap into the network cabling at an uncontrolled location, such as a closet or through a ceiling panel.

Accordingly, a need exists for security measures for controlling access to a network connection. In particular, a need exists for a method for selectively providing access to a network. A need also exists that satisfies the above requirements, and does not permit access to the network at anywhere but a network access port.

### SUMMARY OF THE INVENTION

The present invention provides for security measures for controlling access to a network connection. A method for selectively providing access to voice and data networks by use of intelligent hardware is presented. The present invention provides security measures for controlling access to a network connection. The present invention provides a method of easier management of information systems.

In one embodiment, an electronic device communicatively coupled to intelligent hardware, also referred to herein as an intelligent data concentrator, initiates a request to access a network. The request is received at the intelligent data concentrator communicatively coupled to the network and configured to allow access to the network according to predetermined criteria. Provided the request satisfies the predetermined criteria, the electronic device is provided access to the network.

In one embodiment, the predetermined criteria may include placing geographic restrictions (e.g., the room the port is located in), temporal restrictions (e.g., weekend or nighttime restrictions), and user class restrictions (e.g., visitor restrictions or low-level employee restrictions), or any combination of multiple criteria, on specific ports. In one embodiment, a central control site manages the predetermined criteria, and transmits the predetermined criteria to each intelligent data concentrator.

In one embodiment, the intelligent hardware comprises a first interface for communicatively coupling the intelligent hardware to a network and a second interface for communicatively coupling the intelligent hardware to a plurality of electronic devices. Coupled to both the first interface and the second interface is a processor. Coupled to the processor is an access provider for receiving a request from an electronic device to access the network at the intelligent hardware and for providing access to the network according to predetermined criteria. In one embodiment, the intelligent hardware has a specific access port serial number associated therewith.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates an exemplary wired desktop cluster coupled to a local area network (LAN) in accordance with one embodiment of the present invention.

FIG. 2 is a block diagram of a cross-sectional view of an intelligent data concentrator in accordance with one embodiment of the present invention.

FIG. 3 is an illustration of a perspective view of an exemplary faceplate of an intelligent data concentrator in accordance with one embodiment of the present invention.

FIG. 4 is a block diagram of an exemplary LAN upon which embodiments of the present invention may be practiced.

FIG. 5 is a flowchart diagram of the steps in a process for selectively providing access to a network in accordance with one embodiment of the present invention.

FIG. 6 is a block diagram of an intelligent data concentrator configured for performing a process of selectively providing access to a network in accordance with an embodiment of the present invention.

### DETAILED DESCRIPTION

In the following detailed description, for purposes of explanation, numerous specific details are set forth in order to provide a thorough understanding of the present invention. However, it will be apparent to one skilled in the art that the present invention may be practiced without these specific details. In other instances, well-known structures and devices are not described in detail in order to avoid obscuring aspects of the present invention.

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here and generally conceived to be a self-consistent sequence of steps of instructions leading to a desired result. The steps are those requiring physical manipulations of data representing physical quantities to achieve tangible and useful results. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving”, “allowing”, “processing”, “interpreting”, “providing” or the like, refer to the actions and processes of a computer system, or similar electronic computing device. The computer system or similar electronic device manipulates and transforms data represented as electronic quantities within the computer system's registers and memories into other data similarly represented as physical quantities within the computer system memories into other data similarly represented as physical quantities within the computer system memories or registers or other such information storage, transmission, or display devices.

Portions of the present invention are comprised of computer-readable and computer executable instructions which reside, for example, in computer-usable media of a computer system. It is appreciated that the present invention can operate within a number of different computer systems including general purpose computer systems, embedded computer systems, and stand alone computer systems specially adapted for controlling automatic test equipment.

The present invention provides a device and method for selectively providing access to voice and data networks by use of intelligent hardware, also referred to herein as an intelligent data concentrator. Specifically, the present invention is a device and method for providing security measures based on predetermined criteria for controlling access to a network connection. In one embodiment, the present invention is a device and method for providing security measures to accessing a corporate network. The described method can be controlled from a remote network management console, providing a central control site for enacting security measures. In one embodiment, access to the network is restricted to electronic devices connecting through intelligent hardware.

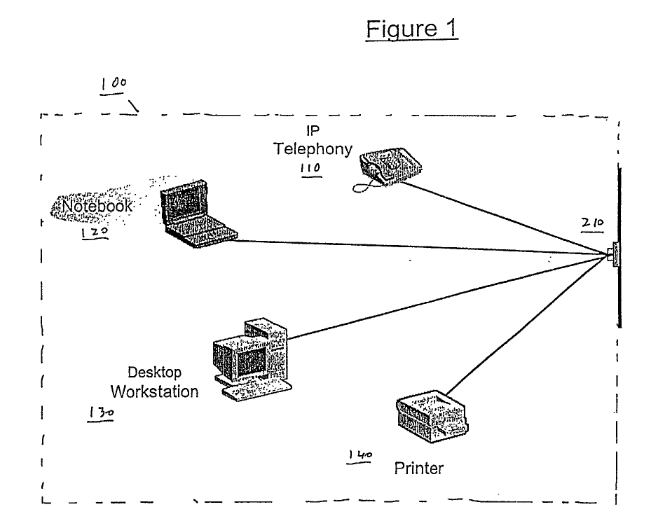

FIG. 1 illustrates an exemplary personal area network (PAN) 100 coupled to a local area network (LAN) 150 in accordance with one embodiment of the present invention. PAN 100 comprises IP telephony 110, notebook 120, desktop workstation 130, and printer 140, each of which is coupled to intelligent data concentrator 210. Intelligent data concentrator 210 is coupled to LAN 150, thus acting as an interface from the various client devices (e.g., comprises IP telephony 110, notebook 120, desktop workstation 130, and printer 140) to LAN 150. It should be appreciated that the various client devices can be communicatively coupled to intelligent data concentrator 210 by either a wired or a wireless connection.

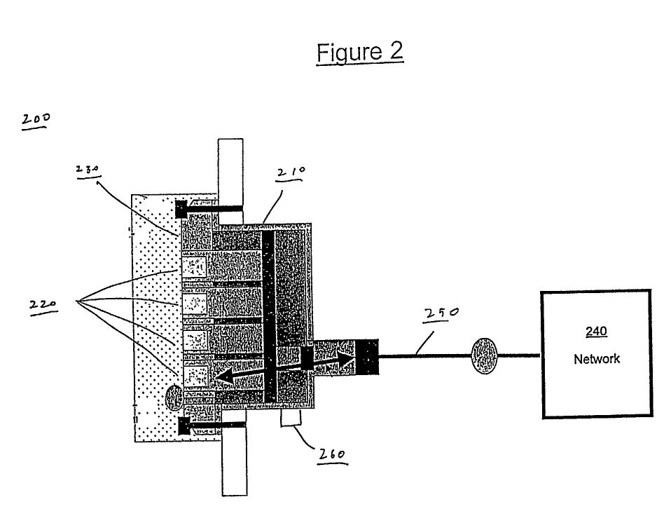

FIG. 2 is a block diagram 200 of a cross-sectional view of an intelligent data concentrator 210 in accordance with one embodiment of the present invention. This embodiment of the present invention implements intelligent hardware that is easy to install and reliably provides an attachment point for access to voice and data networks 240. The embodiment is implemented through miniaturized hardware that can be installed inside of a wall or in internal space provided for in an office cubicle. One surface 230 of this embodiment is intended to be accessible by the end user and would in most instances be on an external surface of a workspace.

In one embodiment, network access is provided through intelligent data concentrator 210 that is physically mounted in the wall of a public area such as a conference room or lobby. The integrity of the protection that intelligent data concentrator 210 offers is enhanced by this type of arrangement since the end user can not readily bypass the unit by gaining access to the network connection.

In one embodiment, mounting hardware attaching intelligent data concentrator 210 to the wall also comprises a tamper detection means 260. In one embodiment, tamper detection means 260 is tamper detection hardware or a tamper detection switch. If a user attempts to circumvent the security measures by physically removing intelligent data concentrator 210, the act of removing the mounting screws would be detected by tamper detection means 260 and an alerting message would be transmitted to the central control site. In one embodiment, the attempt would be logged and a control message could be sent to the head end switch or router that would disallow network traffic on the segment that intelligent data concentrator 210 was attached to.

A plurality of standard communications ports 220 are mounted on the external surface 230 of this embodiment. In one embodiment, communication port 220 is an RJ-45 jack. In another embodiment, communication port 220 is an RJ-11 jack. It should be appreciated that communication port 220 is not limited to any particular jack, and that any type of communication port can be used. Additionally, while intelligent data concentrator 210 illustrates four communication ports 220, it should be appreciated that alternative implementations could support a greater or lesser number of communication ports 220.

Connections to the central data (LAN) or voice network 240 are terminated at intelligent data concentrator 210 for coupling to communication ports 220. Termination of the network cabling 250 (voice or data) will provide for both a reliable electrical and mechanical connection for industry standard communications cabling such as CAT-3, CAT-5, CAT-5E or similar cabling.

In addition to wired connections to and from this embodiment and the client devices, wireless connectivity is a viable method. Infrared (IR), BlueTooth, 802.11 or other means could be utilized to communicate with the device.

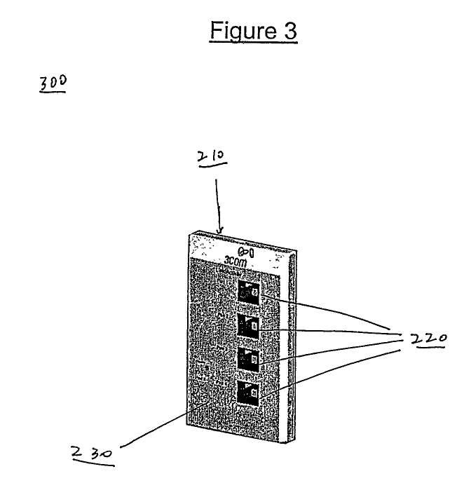

FIG. 3 is an illustration of a perspective view 300 of an exemplary user-accessible surface 230 of an intelligent data concentrator 210 in accordance with one embodiment of the present invention. A user is able to connect data devices to a voice or data network through communications ports 220. As described above, the integrity of the protection that intelligent data concentrator 210 offers is enhanced by this type of arrangement since the end user can not readily bypass intelligent data concentrator 210 to gain access to the network connection.

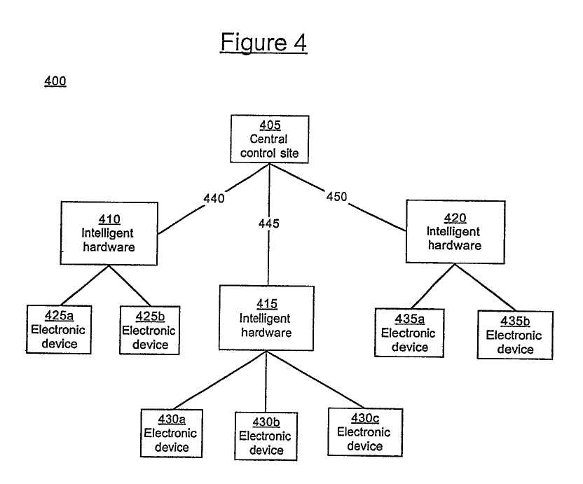

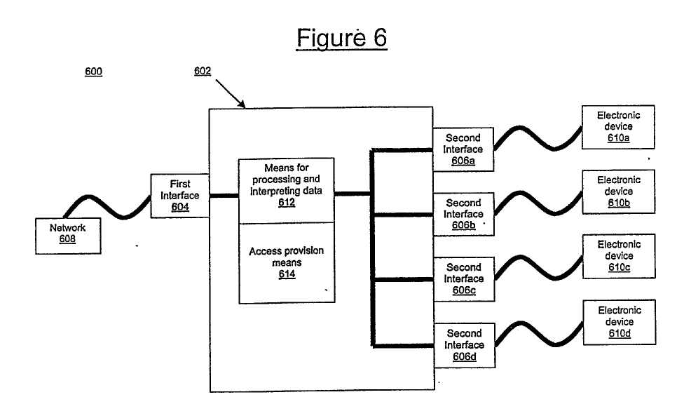

FIG. 4 is a block diagram of an exemplary LAN 400 upon which embodiments of the present invention may be practiced. LAN 400 comprises a central control site 405 and intelligent hardware 410, 415, and 420. In one embodiment, intelligent hardware 410, 415 and 420 are intelligent data concentrators (e.g., intelligent data concentrator 210 of FIG. 2 or intelligent data concentrator 602 of FIG. 6). In one embodiment, central control site 405 can access the intelligence of intelligent hardware 410, 415 and 420. In another embodiment, central control site 405 is a central data switch or hub. Intelligent hardware 410, 415 and 420 are communicatively coupled to central control site 405 over links 440, 445 and 450, respectively. In one embodiment, links 440, 445 and 450 are network cabling.

In one embodiment, intelligent hardware 410, 415 and 420 are connected to central control site 405 by means of network cabling. In the current embodiment, CAT 3 or 5 cabling is used and an Ethernet physical interface is employed. However, it should be appreciated that the present invention will work with other types of LANs, such as LANs with differing physical connections or adopted for use in RF wireless and optical systems.

Intelligent hardware 410 is coupled to electronic devices 425a and 425b. Similarly, intelligent hardware 415 is coupled to electronic devices 430a, 430b and 430c, and intelligent hardware 420 is coupled to electronic devices 435a and 435b. It should be appreciated that electronic devices can comprise any number of data devices or client devices, including but not limited to: computer systems, printers, voice IP telephones, and fax machines configured for use over voice IP networks. It should be further appreciated that electronic devices coupled to intelligent hardware can be coupled by either a wired or a wireless connection. In the event of a wireless connection, intelligent data concentrator 210 can operate as part of the wireless authentication protocol.

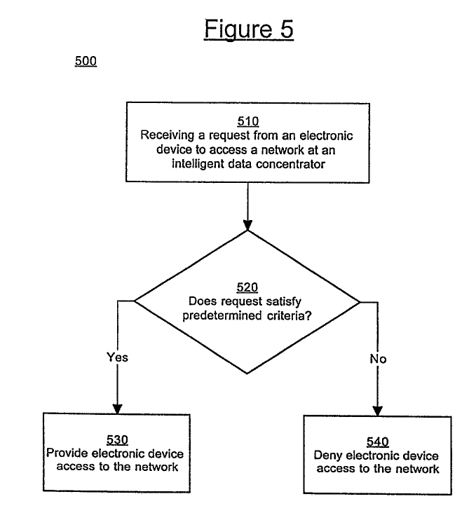

FIG. 5 is a flowchart diagram of the steps in a process 500 for selectively providing access to a network in accordance with one embodiment of the present invention. Steps of process 500, in the present embodiment, may be implemented with any computer languages used by those of ordinary skill in the art.

At step 510, a request to access a network is received at intelligent hardware (e.g., intelligent data concentrator 210 of FIG. 2 or intelligent data concentrator 602 of FIG. 6) communicatively coupled to the network. The intelligent data concentrator is configured to allow access to the network according to predetermined criteria. In one embodiment, the request is initiated by an electronic device communicatively coupled to the intelligent data concentrator. It should be appreciated that electronic devices can comprise any number of data devices or client devices, including but not limited to: computer systems, printers, voice IP telephones, and fax machines configured for use over voice IP networks.

In one embodiment, each intelligent data concentrator has a specific access port serial number associated therewith. The serial number is deployed at installation and the installed units cannot be moved without the central control site being alerted to an attempt to move the intelligent data concentrator. The present embodiment provides a high level of access control for each intelligent data concentrator.

At step 520, the intelligence of the intelligent data concentrator (e.g., means for processing and interpreting data 612 of FIG. 6) determines whether the request satisfies predetermined criteria. The nature and type of data traffic that a user has access to from a network connection that is accessed through the intelligent data concentrator is determined by predetermined criteria. The criteria are defined at a central control site. In one embodiment, the central control site is a remote network management console.

In one embodiment, the criteria established are tailored according to several factors. For example, the criteria may pertain to the registration status of a user, the type of location the user is accessing from (e.g. public or private), or the time of day. In one embodiment, commands to update and change the characteristics of the permitted types of traffic are managed by an encrypted exchange between the central control site and the intelligent data concentrators. The filtering of traffic through the device is implemented by traditional firewall techniques.

In one embodiment, criteria is established where network connections initiated from a public space, such as a conference room connected to a public lobby, are limited to the access of the public internet while restricting all traffic to and from the corporate intranet. In another embodiment, criteria is established that operates to block all access from specific geographic locations outside of the normal business hours.

In certain instances it might be desirable to enable a higher degree of access to specific identified and trusted users. In one embodiment, the intelligent data concentrator comprises an identification means configured to read an identification verification means. In one embodiment, the identification means is identification hardware, such as an identification badge reader. In one embodiment, the identification verification means is an access control badge or other identification tokens are used to control the degree of access. The detection of a badge by a reader could initiate a request transmission that would be logged and would then forward a request to the network control application. Once the request was received, criteria that enable a greater degree of access (e.g., access to corporate Intranet) could be sent to the intelligent data concentrator. Alternately, once identified, a specific user may be denied access to the network from a certain locations, thus limiting the number of predefined locations a user may access the network from.

In one embodiment, the criteria allowing greater access could be retained for the duration of the current session and automatically revert to a restrictive set when the user logs out or when a sensor detected that the user had left the room. In the present embodiment, the badge reader is the same system that is commonly used to control physical access to certain locations. In another embodiment, utilizing password control or biometric identification for identifying the end user is employed.

Returning to FIG. 5, if the request satisfies the predetermined criteria, as shown in step 530 of process 500, the electronic device is provided access to the network. Alternatively, if the request does not satisfy the predetermined criteria, as shown in step 540, the electronic device is denied access to the network.

FIG. 6 is a block diagram 600 of an intelligent data concentrator 602 configured for performing a process of selectively providing access to a network in accordance with an embodiment of the present invention.

Intelligent data concentrator 602 comprises a first interface 604 for communicatively coupling intelligent data concentrator 602 to network 608. Intelligent data concentrator 602 also comprises a plurality of second interfaces 606a-d for communicatively coupling intelligent data concentrator 602 to a plurality of electronic devices 610a-d. In one embodiment, second interfaces 606a-d are communication ports (e.g., communication ports 220 of FIG. 2). It should be appreciated that there can be any number of second interfaces 606a-d, and that the present invention is not meant to limit the number of second interfaces 606a-d. First interface 604 operating in conjunction with second interfaces 606a-d operates to connect electronic devices 610a-d to network 608.

Intelligent data concentrator 602 also comprises means for processing and interpreting data 612 coupled to the first interface 604 and access provision means 614 coupled to the means for processing and interpreting data 612. Means for processing and interpreting data 612 is intended to include, but not limited to: a processor, a robust processor, a central processing unit (CPU), and a random access memory (RAM).

Access provision means 614 is intended to include, but not limited to: a hardware access provider, a network connection filter, a software access provider and a firmware access provider. In one embodiment, access provision means 614 is an access provider for selectively providing electronic devices with access to a network. In one embodiment, access provision means 614 is a software implementation for selectively providing electronic devices with access to a network. In one embodiment, access provision means 614 operates in conjunction with a central control site (e.g., central control site 405 of FIG. 4) of network 608 for performing fault detection.

The preferred embodiment of the present invention, a device and method for selectively providing access to voice and data networks by use of intelligent hardware, is thus described. While the present invention has been described in particular embodiments, it should be appreciated that the present invention should not be construed as limited by such embodiments, but rather construed according to the below claims.

1. A method for selectively providing access to a network, said method comprising the steps of:
a) receiving a request to access said network at intelligent hardware communicatively coupled to said network and configured to allow access to said network according to predetermined criteria, said request initiated by an electronic device communicatively coupled to said intelligent hardware; and
b) provided said request satisfies said predetermined criteria, allowing said electronic device to access said network such that said electronic device is communicatively coupled to said network through said intelligent device.

2. A method as recited in claim 1 wherein said intelligent hardware comprises:
a first interface for communicatively coupling said intelligent hardware to said network;
a second interface for communicatively coupling said intelligent hardware to a plurality of said electronic devices such that each said electronic device is communicatively coupled to said network;
a processor coupled to said first interface and said second interface; and
an access provider coupled to said processor.

3. A method as recited in claim 1 wherein said electronic device is a client device.

4. A method as recited in claim 1 wherein said intelligent hardware is communicatively coupled over said network to a central control site, said central control site for defining said predetermined criteria and for transmitting said predetermined criteria to said intelligent hardware.

5. A method as recited in claim 1 wherein said predetermined criteria are for providing access to said network based on a registration status of a user.

6. A method as recited in claim 1 wherein said predetermined criteria are for providing access to said network based on a type of location where said intelligent hardware resides.

7. A method as recited in claim 1 wherein said predetermined criteria are for providing access to said network based on a time of day.

8. A method as recited in claim 7 wherein said providing access is implemented by traditional firewall techniques.

9. A method as recited in claim 1 wherein said intelligent hardware has a predefined serial number associated therewith.

10. A method as recited in claim 1 wherein said intelligent hardware comprises tamper detection hardware for detecting attempts at accessing said network by bypassing said intelligent hardware.

11. A method as recited in claim 1 wherein said intelligent hardware comprises identification hardware configured to read an identification badge such that access to said network is provided based on said identification badge.

12. An intelligent device for providing access to a network comprising:
a first interface for communicatively coupling said intelligent device to said network;
a second interface for communicatively coupling said intelligent device to a plurality of electronic devices such that said plurality of electronic devices is communicatively coupled to said network through said intelligent device;
a processor coupled to said first interface and said second interface; and
an access provider coupled to said processor, said access provider configured to receive a request to access said network at said intelligent device and configured to provide access to said network according to predetermined criteria, said request initiated by one of said plurality of electronic devices.

13. A method as recited in claim 12 wherein said plurality of electronic devices comprises at least one client device.

14. An intelligent device as recited in claim 12 wherein said intelligent device is communicatively coupled over said network to a central control site, said central control site for defining said predetermined criteria and for transmitting said predetermined criteria to said intelligent device.

15. An intelligent device as recited in claim 12 wherein said predetermined criteria are for providing access to said network based on a registration status of a user.

16. An intelligent device as recited in claim 12 wherein said predetermined criteria are for providing access to said network based on a type of location where said intelligent device resides.

17. An intelligent device as recited in claim 12 wherein said predetermined criteria are for providing access to said network based on a time of day.

18. An intelligent device as recited in claim 12 wherein said providing access is implemented by traditional firewall techniques.

19. An intelligent device as recited in claim 12 wherein said intelligent device has a predefined serial number associated therewith.

20. An intelligent device as recited in claim 12 further comprising identification hardware configured to read an identification verifier such that access to said network is provided based on said identification verifier.

21. An intelligent device as recited in claim 12 further comprising tamper detection hardware for detecting attempts at accessing said network by bypassing said intelligent device.

22. An intelligent device for providing access to a network comprising:
a first interface for communicatively coupling said intelligent device to said network;
a second interface for communicatively coupling said intelligent device to a plurality of electronic devices such that said plurality of electronic devices is communicatively coupled to said network through said intelligent device;
a means for processing and interpreting data coupled to said first interface and said second interface; and
an access provision means coupled to said means for processing and interpreting data, said access provision means for receiving a request to access said network at said intelligent device and for providing access to said network according to predetermined criteria, said request initiated by one of said plurality of electronic devices.

23. A method as recited in claim 22 wherein said plurality of electronic devices comprises at least one client device.

24. An intelligent device as recited in claim 22 wherein said intelligent device is communicatively coupled over said network to a central control site, said central control site for defining said predetermined criteria and for transmitting said predetermined criteria to said intelligent device.

25. An intelligent device as recited in claim 22 wherein said predetermined criteria are for providing access to said network based on a registration status of a user.

26. An intelligent device as recited in claim 22 wherein said predetermined criteria are for providing access to said network based on a type of location where said intelligent device resides.

27. An intelligent device as recited in claim 22 wherein said predetermined criteria are for providing access to said network based on a time of day.

28. An intelligent device as recited in claim 22 wherein said providing access is implemented by traditional firewall techniques.

29. An intelligent device as recited in claim 22 wherein said intelligent device has a predefined serial number associated therewith.

30. An intelligent device as recited in claim 22 further comprising identification means configured to read an identification verification means such that access to said network is provided based on said identification verification means.

31. An intelligent device as recited in claim 22 further comprising tamper detection means for detecting attempts at accessing said network by bypassing said intelligent device.
